(19) United States
(12) Patent Application Publication
(10) Pub. No.: US 2010/0018211 A1
(43) Pub. Date: Jan. 28, 2010

(54) Gas turbine transition piece having dilution holes

(75) Inventors: Krishna K. Venkataraman, Simpsonville, SC (US); William Kirk Hessler, Greer, SC (US); Predrag Popovic, Simpsonville, SC (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/219,534

(22) Filed: Jul. 23, 2008

(51) Int. Cl. F02C 7/00; F02C 7/16

(52) U.S. Cl. 60/754

(57) ABSTRACT

A gas turbine transition piece includes a duct body having a forward end and an aft end, the duct body defining an enclosure for confining a flow of combustion products from a combustor to a turbine first stage nozzle. A plurality of dilution holes are formed in the duct body, located at selected X, Y, Z coordinates measured from a zero reference point at a center of an exit plane of the transition piece.

This invention relates to gas turbine combustor technology and, more specifically, to a transition piece utilized for flowing hot combustion gases between the turbine combustor and a first stage turbine nozzle.

### BACKGROUND OF THE INVENTION

It is well known that air pollution emissions are typically produced in gas turbines burning conventional hydrocarbon fuels. Those emissions are usually oxides of nitrogen, carbon monoxide and unburned hydrocarbons. It is also well known that both oxidation of molecular nitrogen and oxidation of carbon monoxide to carbon dioxide are dependent upon the temperature of the hot gas stream produced by the turbine combustor which flows through the transition piece to the first stage nozzle. To improve the performance of the combustor with respect to emissions, gas temperatures have to be high enough for an adequate period of time to oxidize carbon monoxide without being so high that excessive amounts of nitrogen oxides are produced.

Various concepts have been proposed to maintain the reaction zone temperature below the level at which NOₓ is formed or by reducing the residence time at high temperatures such that there is insufficient time for the NOₓ formation reaction to go forward, or both. One method of reducing the temperature of the reaction zone in the combustor is to provide a lean mixture of fuel and air prior to combustion. The lean mixture may be achieved at least in part by supplying dilution air to the combustor liner to absorb heat and reduce the temperature rise to a level where thermal NOₓ is not formed. However, in many cases, even with lean premixed fuel and air, the temperatures are sufficiently high to produce undesirable emissions.

It has also been proposed to supply dilution air to the transition piece between the combustor and the first stage nozzle. For example, in one prior transition piece, two dilution holes are located adjacent the outlet of the transition piece, close to the first stage nozzle.

In commonly owned Publication No. US 2005/0204741 A1, there is provided a transition piece dilution air management system which promotes dilution mixing and emissions reduction. Particularly, the dilution air management system provides dilution air jets in the transition piece at predetermined axial and circumferential locations to optimize reductions in emissions consistent with efficient use of compressor discharge air. However, undesirable emissions remain a problem notwithstanding the various prior proposals.

### BRIEF DESCRIPTION OF THE INVENTION

In one exemplary but nonlimiting embodiment, the present invention relates to a gas turbine transition piece comprising a duct body having a forward end and an aft end, the duct body defining an enclosure for confining a flow of combustion products from a combustor to a turbine first stage nozzle; and a plurality of dilution holes formed in the duct body, at locations defined by selected X, Y, Z coordinate sets listed in Table I, the X, Y and Z coordinates measured from a zero reference point at a center of an exit plane of the transition piece.

In another aspect, the invention relates to a gas turbine transition piece comprising a duct body having a forward end and an aft end, the body defining an enclosure for confining a flow of combustion products from a combustor to a turbine first stage nozzle; and a plurality of dilution holes formed in the duct body at locations defined by selected sets of X, Y, Z coordinate sets listed in Table I, the X, Y, and Z coordinate sets measured from an origin at a center of an exit plane at the aft end of the transition piece, wherein the duct body has a length of substantially 20 inches, and wherein the plurality of dilution holes have diameters in a range of from 0.3 to 1.75 inches.

In still another aspect, the invention relates to a gas turbine transition piece comprising a duct body having a forward end and an aft end and a length of substantially 20 inches, the body defining an enclosure for confining a flow of combustion products from a combustor to a turbine first stage nozzle; and between 5 and 17 dilution holes formed in the duct body, wherein the plurality of dilution holes have diameters in a range of from 0.3 to 1.75 inches, and a combined cross-sectional open area of between 2 and 7.5 square inches, the dilution holes having locations selected from any combination of X, Y and Z coordinate sets listed in Table I.

The invention will now be described in connection with the drawings identified below.

### BRIEF DESCRIPTION OF THE DRAWINGS

FIG. 1 is a cross section through a conventional gas turbine combustor and transition piece;

FIG. 2 is a top view of a transition piece incorporating dilution holes in accordance with an exemplary but nonlimiting embodiment of the invention; and

FIG. 3 is a side elevation view of the transition piece shown in FIG. 2; and

FIG. 4 is an aft end view of the transition piece shown in FIGS. 2 and 3 where reference exit plane origin point is shown.

### DETAILED DESCRIPTION OF THE INVENTION

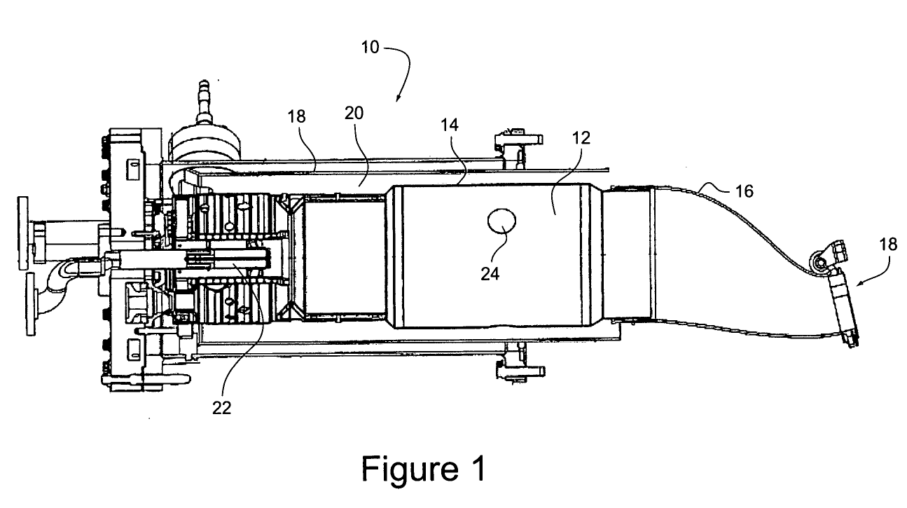

Referring now to the drawings, and particularly to FIG. 1, there is illustrated a known combustor 10 for a gas turbine which includes a combustion chamber 12 defined in part by a combustor liner 14 connected at its aft end to a transition piece or duct body 16 which confines the flow of combustion products to a flow path which supplies the combustion products (or gases) to the first turbine stage nozzle, represented by reference numeral 18. The combustor 10 may be one of several arranged in a “can-annular” array about the turbine rotor, each supplying gas to the first stage turbine nozzle. Air for the combustion process is typically supplied by compressor discharge air which is reversed flowed (i.e., in a direction opposite the flow direction of the combustion gases) exteriorly of the transition piece and the combustor liner to air inlets at the forward end of each combustor. A generally cylindrical flow sleeve 18 surrounds the combustor liner 14 and provides an annular passageway 20 between the combustor liner and the flow sleeve for supplying air to the forward end of the combustor. The flow sleeve 18 may be provided with cooling holes for impingement cooling the combustor liner, and a similar second flow sleeve (not shown), also provided with cooling holes, may be arranged about the transition piece and connected end-to-end with the flow sleeve 18. In each combustor, an array of primary nozzles 21 in endcovers combined with a center nozzle 22 supplies fuel to the combustion chamber that mixes with the discharge air from the compressor to create premix combustion flame that resides on parts 12 and 16.

In a typical arrangement, the combustor liner may have one or more dilution holes 24 that were moved from liner 12 to the transition piece 16 to allow a significant reduction in emissions and improved premix flame stability.

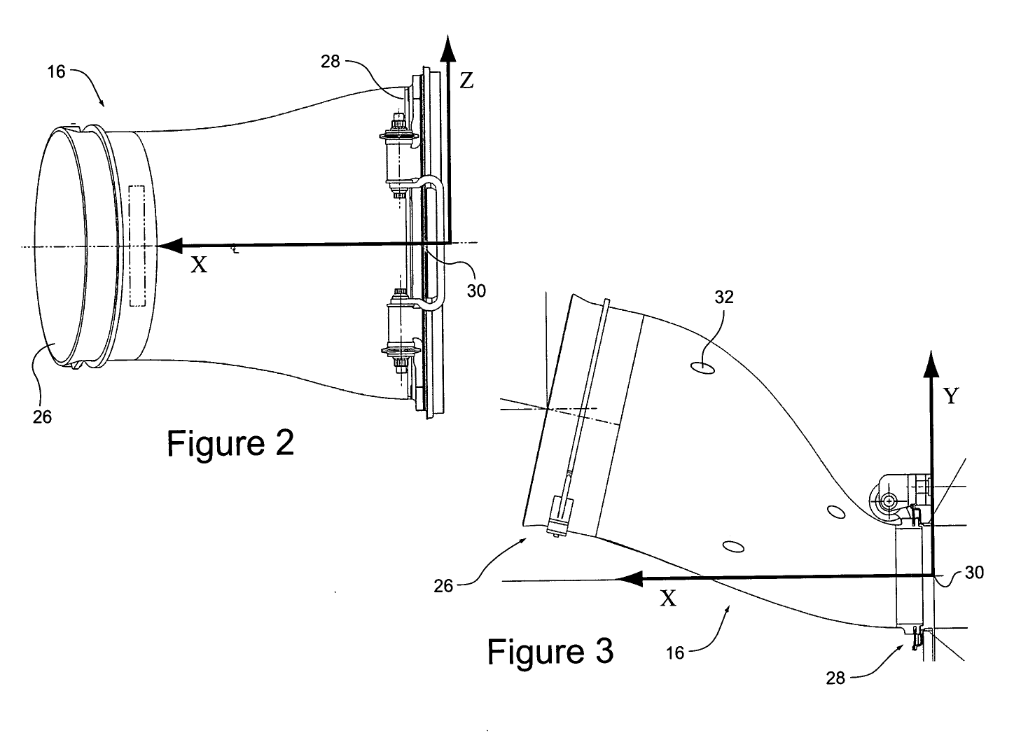

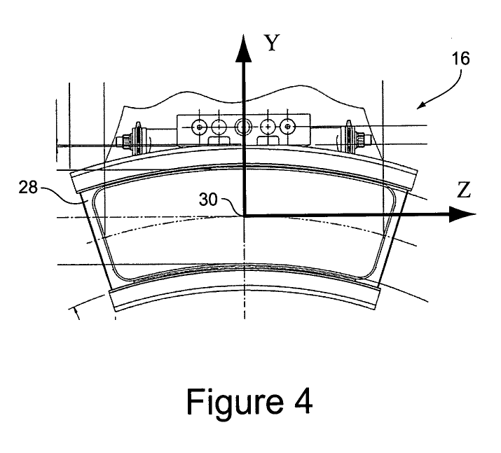

With further reference to FIGS. 2-4, the present invention relates to a unique arrangement of dilution holes in the transition piece 16, the number, size and location of which promote dilution air mixing, allow for longer combustion residence time, (thus also enabling a more stable formation of combustion flame zones), improve flame stability and facilitate complete burning of hydrocarbons. The transition piece 16 is essentially a duct body or enclosure having a forward end 26 and an aft end 28, with the cross-sectional shape of the duct body varying from a substantially cylindrical shape at the forward end to a curved rectangular shape at the aft end.

In an exemplary but nonlimiting embodiment, plural dilution holes 32 (three are shown in FIG. 3 by way of example only) are formed in the transition piece 16, located precisely along and about the duct body, as measured in inches along X, Y and Z coordinates, from an origin or zero reference point 30, at the center of the transition piece (or duct body) exit plane. The X coordinate extends from the origin 30 in an upstream direction, i.e., in a direction opposite the flow through the transition piece. In this exemplary embodiment, the transition piece is about twenty inches in length. Twenty eight (28) dilution hole locations have been identified as viable locations for realizing emissions reductions. The X, Y, Z coordinates of the twenty eight dilution hole locations are set out in Table I below.

TABLE I

| HOLE # | X | Y | Z |
|---|---|---|---|
| 1 | 14.59 | 10.26 | 4.78 |
| 2 | 16.45 | 2.21 | 0 |
| 3 | 14.59 | 10.26 | −4.78 |
| 4 | 13.97 | 12.96 | 0 |
| 5 | 15.82 | 4.91 | 4.78 |
| 6 | 15.82 | 4.91 | −4.78 |
| 7 | 10.63 | 1.25 | −5.6 |
| 8 | 10.91 | 1 | 5.05 |
| 9 | 8.84 | −0.97 | 2.9 |
| 10 | 8.84 | −0.9 | −2.27 |
| 11 | 6.9 | 7.44 | 2 |
| 12 | 4.59 | 4.485 | −5.23 |
| 13 | 4.59 | 3.56 | 0 |
| 14 | 4.59 | −2.11 | 0 |
| 15 | 2.59 | 0.06 | 7.647 |
| 16 | 2.59 | −2.21 | 6.92 |
| 17 | 2.59 | −2.98 | 4.33 |
| 18 | 2.59 | −2.56 | 0 |
| 19 | 2.59 | −2.98 | 4.33 |
| 20 | 2.59 | −1.07 | −7.29 |
| 21 | 4.09 | 3.7 | 1.82 |
| 22 | 4.09 | 3.12 | 5.42 |
| 23 | 4.09 | −2.9 | 4.76 |
| 24 | 4.09 | −2.9 | −4.76 |
| 25 | 4.09 | −2.21 | −6.92 |
| 26 | 4.09 | 3.197 | 5 |
| 27 | 4.09 | −3.7 | 1.82 |
| 28 | 4.09 | −3.7 | −1.82 |

The number of dilution holes provided in the transition piece or duct body 16 may vary between five (5) and seventeen (17), with eleven (11) being the optimum number in the exemplary embodiment. The holes 32 lie along the transition piece or duct body in an envelope within one inch in any direction along the surface of the transition piece from the locations of the holes determined by the X, Y and Z coordinates. In this regard, any combination of the twenty eight hole location sites listed in Table I may be selected for the 5-17 dilution holes. The dilution hole diameter may be in the range of from 0.3 to 1.75 in. and the combined open surface area of the dilution holes should be in the range of from 2 to 7.5 sq. inches. The dilution holes 32 may have uniform or different diameters within the specified range.

The dilution hole arrangement as described allows for longer combustion residence time (due to increased temperature of combustion gases) and hence additional CO burnout. This also enables more stable formation of the combustion flame zone, and improves flame stability instead of quenching the combustion process prior to complete burning of hydrocarbons. The end result is a significant reduction in harmful emissions and improved liner durability.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas turbine transition piece comprising a duct body having a forward end and an aft end, said body defining an enclosure for confining a flow of combustion products from a combustor to a turbine first stage nozzle; and a plurality of dilution holes formed in said duct body at locations defined by selected X, Y, Z coordinate sets listed in Table I, said coordinate measured from a zero reference point at a center of an exit plane of the transition piece, thereby increasing combustion residence time, improving premix flame stability, and reducing emissions.

2. The transition piece of claim 1 wherein said plurality of dilution holes have uniform diameters in a range of from 0.3 to 1.75 inches.

3. The transition piece of claim 1 wherein some or all of said plurality of dilution holes have different diameters within a range of from 0.3 to 1.75 inches.

4. The transition piece of claim 1 wherein said plurality of dilution holes have a combined cross-sectional open area of between 2 and 7.5 square in.

5. The transition piece of claim 1 wherein said duct body has a substantially circular cross section at said forward end, and a curved rectilinear shape at said aft end.

6. The transition piece of claim 1 wherein said plurality of dilution holes comprises between 5 and 17 holes having locations selected from any combination of X, Y and Z coordinate sets listed in Table I.

7. The transition piece of claim 6 wherein said plurality of dilution holes comprises 11 dilution holes having locations selected from any combination of X, Y and Z coordinate sets listed in Table I.

8. The transition piece of claim 4 wherein some or all of said plurality of dilution holes have different diameters within a range of from 0.3-1.75 inches.

9. A gas turbine transition piece comprising a duct body having a forward end and an aft end, said body defining an enclosure for confining a flow of combustion products from a combustor to a turbine first stage nozzle; and a plurality of dilution holes formed in said duct body at locations defined by selected sets of X, Y, Z coordinate sets listed in Table I, said X, Y, and Z coordinate sets measured from an origin at a center of an exit plane at said aft end of the transition piece, wherein said duct body has a length of substantially 20 inches, and wherein said plurality of dilution holes have diameters in a range of from 0.3 to 1.75 inches.

10. The transition piece of claim 9 wherein said plurality of dilution holes have a combined cross-sectional open area of between 2 and 7.5 square inches.

11. The transition piece of claim 9 wherein said duct body has a substantially circular cross section at said forward end, and a curved rectilinear shape at said aft end.

12. The transition piece of claim 9 wherein said plurality of dilution holes comprises between 5 and 17 holes.

13. The transition piece of claim 12 wherein said plurality of dilution holes comprises 11 holes.

14. A gas turbine transition piece comprising a duct body having a forward end and an aft end and a length of substantially 20 inches, said body defining an enclosure for confining a flow of combustion products from a combustor to a turbine first stage nozzle; and between 5 and 17 dilution holes formed in said duct body, wherein said plurality of dilution holes have diameters in a range of from 0.3 to 1.75 inches, and a combined cross-sectional open area of between 2 and 7.5 square inches, said dilution holes having locations selected from any combination of X, Y and Z coordinate sets listed in Table I.

15. The transition piece of claim 16 wherein said plurality of dilution holes comprises 11 holes.
